(19) United States
(12) Patent Application Publication
(10) Pub. No.: US 2010/0238179 A1
(43) Pub. Date: Sep. 23, 2010

(54) Presentation of Personalized Weather Information by an Animated Presenter

(76) Inventor: Terence F. Kelly, Madison, WI (US)

Correspondence Address: BOYLE FREDRICKSON S.C., 840 North Plankinton Avenue, MILWAUKEE, WI, 53203, US

(21) Appl. No.: 12/664,579

(22) PCT Filed: Jun. 12, 2008
(86) PCT No.: PCT/US08/66676

§ 371 Date: Jun. 9, 2010

Related U.S. Application Data
(60) Provisional application No. 60/934,309, filed on Jun. 12, 2007.

(51) Int. Cl. G06T 13/00

(52) U.S. Cl. 345/473

(57) ABSTRACT

A computer-implemented personalized weather presentation method. The method includes generating personalized weather information (68) and presenting the personalized weather information (68) using a user-selected weather presentation animated presenter (232). The presentation is configured (214, 222) based on the content of the generated personalized weather information (68).

### FIELD OF THE INVENTION

The present invention pertains generally to systems and methods for producing and presenting weather reports and warnings, including current weather conditions, weather forecasts, and severe weather warnings, and, more particularly, to systems and methods for generating weather reports and warnings that are personalized for individual users and for presenting such personalized reports and warnings to individual users via an animated presenter.

### BACKGROUND OF THE INVENTION

Most of the current weather and weather forecast information used by individuals and businesses is obtained by them from weather reports provided by local television and radio stations. Such reports are typically prepared by meteorologists at a television or radio station serving a particular geographical area, e.g., a large city and surrounding environs. The reports are based on current weather information available to the meteorologist which may be provided by various local (e.g., local radar) and national (e.g., NEXRAD radar and weather satellite) weather information sources. A meteorologist may also employ computer implemented weather forecasting models in preparing a weather forecast report. A meteorologist may prepare and/or update several such reports throughout the day, and such reports may be provided as part of periodic radio and/or television broadcasts. Such weather reports and forecasts may also be provided in printed form, e.g., in a daily newspaper. A person who is interested in the current or forecast weather conditions for a geographic location accesses such a weather report by tuning in to the television or radio broadcast of the report at the designated time, reading the paper, etc. If severe weather threatens a particular area, an emergency radio or television broadcast may be made to provide such information to the public immediately, and, if necessary, continuously. For example, a television station may provide a graphic indication of the general location (e.g., county) and nature of severe weather, (e.g., tornado, and thunderstorm warnings, etc.) as part of its television broadcast, throughout the period during which severe weather threatens an area.

A severe limitation of such conventional weather reports and forecasts is that they are generalized over a large geographic area and, typically, an extensive period of time. For example, a typical conventional weather forecast will provide predicted high and low temperatures, sky conditions, precipitation, etc., for the day, or for several days, for a particular geographical area, e.g., the city where the television or radio station is located and the surrounding area. However, the actual current and forecast weather conditions for the downtown area of a city, the suburbs, and surrounding rural areas will, of course, be different. For example, different areas in and around the city will achieve different high and low temperatures at different times during the day, and precipitation will reach different points in a television station's viewing area at different times during the day and at different levels of intensity. A meteorologist's forecast may indicate that some areas within a television station's viewing area will receive significant precipitation during the day, while other areas will receive none (e.g., a forecast of “widely scattered showers”). Thus, generalized weather conditions and forecasts for a particular area, e.g., a television or radio station viewing and/or listening area, may be of limited use to any particular individual, especially individuals living or working outside of a central city area, in that such general information will not provide an accurate indication of, e.g., high and low temperatures and sky conditions at any particular time during the day at that individual's home or place of work, and when, how much, or even if precipitation will arrive at that individual's home or place of work. Businesses, in particular, may require more specific and detailed weather forecast information. For example, the forecast weather conditions at a particular construction location may be used to decide which activities will take place at that site on a particular day. Generalized weather forecasts for a relatively large area are of limited usefulness to such businesses.

The National Weather Service issues weather forecasts. However, such forecasts are “zone” forecasts generalized over National Weather Service “zones” which may cover a hundred miles square or more. Thus, such National Weather Service forecasts also do not provide an individual or business with a detailed or accurate weather forecast for a particular localized area of interest.

A solution to the problem of providing only generalized weather forecast reports covering a wide geographic area is presented in U.S. Pat. Nos. 6,498,987, 6,823,263, and 7,058,510, all entitled System and Method for Providing Personalized Weather Reports and the Like. These patents describe a system and method for generating weather reports and the like which are precisely computed automatically for a particular individual or business user's geographic Location, e.g., home or work, and which are provided automatically directly to the individual user or business. Such a system and method may also provide personalized advanced notice to a user when forecast weather conditions meet a user definable weather condition profile for outdoor activities of interest to the user. In such a system a user establishes an individualized user profile in which the user defines a particular location of interest (e.g., home or work), a contact address (e.g., e-mail address or pager number) to which the personalized weather report is to be delivered, and, optionally, a personalized activity weather condition profile, establishing a preferred weather condition profile for activities of interest. Alternatively, or additionally, an address at which the personalized weather report is to be made available, e.g., a personalized interne web page address, may be, automatically generated and provided to the user. A detailed and accurate weather forecasting model is run to provide high geographical and temporal resolution forecast data. This high resolution forecast data is compared to the individual user profile and a personalized weather report for the particular location, times, and conditions of interest to the individual is provided directly to the individual or business, e.g., via e-mail and/or at the user's personalized internet web page address. Individual personalized weather reports generated from pre-established user profile information and model forecast data may be generated and delivered and/or updated automatically, without human intervention, e.g., each time the forecast model is run. The personalized weather report may be presented using text and graphics, which may be animated to show, e.g., moving weather systems overlaid on a map showing the changing position of the weather system with respect to the user location of interest that is also indicated on the map.

The limitations of generalized weather forecast reports apply also, and perhaps more significantly, to reports of severe weather conditions. If severe weather threatens a particular area, an emergency radio or television broadcast may be made to provide such information to the public immediately and, if necessary, continuously. For example, a television station may provide a graphic indication of the general location (e.g., county) and nature of severe weather (e.g., tornado and thunderstorm warnings, etc.) as part of its television broadcast, throughout the period during which severe weather threatens an area. Such severe weather or storm warnings may be generated from various different weather information sources and provided in various different manners to the public. For example, a television station may subscribe to National Weather Service weather wire information, which includes weather warning bulletins authored by the National Weather Service Storm Prediction Center, and other related government agencies. The weather warning bulletins include tornado warnings, severe thunderstorm warnings, flash flood warnings, and the like. This information is typically employed by W×Warn, or other systems, for displaying the warning bulletins, e.g., as an overlay on a television broadcast.

A limitation of such conventional storm warnings is that they are generalized over a relatively large geographic area. For example, a typical storm warning may indicate that severe weather, e.g., a tornado, thunderstorm, etc., is present or expected to arrive in a geographic area such as a county. Of course, such severe weather will arrive at different locations in the county at different times, and some areas of a county under a weather warning may not receive any severe weather at all. A county-wide storm warning, therefore, does not provide sufficient information for an individual to know whether or when to expect severe weather at his home, place of work, or other specific location of interest within the county. Televised weather reports which provide expected arrival times of severe weather at specific cities or other populated areas are also of limited value for many individuals. Such reports, which may employ NEXRAD information or NEXRAD information in combination with live radar information to provide accurate storm cell tracking, typically only provide arrival time information for a handful of populated areas in the path of a storm. Those in rural areas and smaller towns in the path of a storm must attempt to estimate on their own, from the graphics provided in the televised weather warning broadcast, if severe weather will reach their area and, if so, when.

Another limitation of conventional televised or radio broadcast storm warnings is that such warnings provide information only on the types of storms which are deemed significant by the television or radio station providing the broadcast. If a televised storm warning provides information on all severe weather conditions (e.g., thunderstorms, hail, tornadoes, etc.) occurring in a television station's service area, a viewer may be overwhelmed with information, and miss the particular severe weather information in which he is interested (e.g., a tornado headed toward his home). Alternatively, if a broadcast storm warning report includes information on only selected severe weather conditions, an individual may not be provided with storm warning information which would be valuable to him, and which is available to the television or radio station, but which is not provided in a storm warning report which is directed to a more general audience. Furthermore, conventional televised or radio broadcast storm warnings provide an amount of advanced storm warning which is selected by the television or radio station to satisfy a general audience. This may be too much or too little for any individual interested in when a storm will reach the individual's location of interest.

Solutions to the foregoing limitations of conventional storm warnings are found in U.S. Pat. Nos. 6,823,263 and 7,139,664, both entitled System and Method for Providing Personalized Storm Warnings. These patents describe a system and method for generating storm warnings which are precisely tailored automatically for a particular individual or business user's geographic location of interest, e.g., home or work, and which may be provided automatically to the individual user or business. Such a system and method allows an individual to identify a particular geographic location for which the user desires a personalized storm warning to be provided, as well as to establish a storm profile, defining attribute characteristics of storms for which a storm warning is desired, and the amount of advanced warning which the personalized storm warning is to provide. In such a system and method a user establishes an individualized user profile, in which the user may define a particular location of interest (e.g., home or work) and a contact address (e.g., e-mail address or pager number) to which a personalized storm warning is to be delivered. A user may also establish a storm profile, defining attribute characteristics of a storm for which the user desires a storm warning to be provided, and an amount of advanced warning to be provided by the personalized storm warning. A detailed and accurate storm track is generated. The storm track includes information describing a storm's characteristics (severe weather conditions) as well as the current location and predicted track of movement of the storm. Such a storm track may be generated automatically from weather radar data, such as NEXRAD data, either alone, or in combination with local live weather radar information, and other available weather information. The generated storm track is compared to the individual user profile. For user profiles defining locations of interest within a predicted storm track, and if the storm track characteristics meet the storm attribute and advanced warning characteristics specified in the storm profile, a personalized storm warning is automatically generated. The personalized storm warning thus generated preferably identifies in detail the storm conditions approaching a user location of interest, and the predicted arrival time at that location. A personalized storm warning in accordance with the present invention may be provided directly to an individual or business, e.g., via e-mail, pager, cellular telephone, etc., in the form of a text message or including graphics, which may be animated. For example, the personalized storm warning may include an animation of storm movement overlaid on a map on which the user location of interest is also indicated.

Although personalized weather forecast reports and warnings of the type just described provide valuable user specific weather information that satisfies individual user's needs, the way in which such information is presented may be improved. Typically such personalized weather information is presented in the form of text and graphics that must be read and interpreted by the individual user to be useful. However, most users are used to weather information being presented to them by a person, such as a local weather reporter or other personality. Users enjoy receiving weather information in this way. Such a presentation creates a more personal connection to the information being presented. What is desired, therefore, is a system and method for providing personalized weather information in a manner that retains the increased accuracy and relevance of user specific personalized weather reports and warnings, while presenting such information in a way that is most familiar and enjoyable for users.

### SUMMARY OF THE INVENTION

The present invention provides a system and method for presenting personalized weather information, such as weather forecast information and severe weather warnings, to individual users via an animated weather presenter. In accordance with the present invention individual users define particular user locations of interest and types of weather information in which they may be interested to create a user profile. Using the information provided in the user profile in combination with weather information sources, such as weather forecast models, weather radar, etc., personalized weather information for individual user locations of interest is generated. This may include personalized and highly detailed weather forecast information for the user location of interest, as well as severe weather warnings indicating that severe weather of interest is likely to affect the user location of interest. From the personalized weather information a personalized forecast report is generated automatically. The personalized weather forecast report may be in the form of a text or other data file that corresponds in substance, if not in exact form, to the words that a human presenter would use to present the personalized weather information. The personalized weather report data file is, in turn, used by a text-to-speech or similar function to generate an audio file containing an audio presentation of the personalized weather information. Preferably the audio presentation is generated in a manner that reflects realistically not only a straight reading of the personalized weather information but also the meaning of the substantive content of the information to the user. The personalized weather report data file, or the personalized weather report audio file, is also used to by an animation routine to define the movements of an animated weather presenter which, when combined with the audio presentation, provides for the generation of an animated weather presenter that presents the personalized weather information to a user in a desired manner. The movements of the animated presenter preferably are controlled to not only match appropriately the mouth movements corresponding to annunciation of the audio presentation, but also the substantive meaning of the weather information being presented to the user. The animated weather presentation may be provided to the user via any addressable device, such as a personal computer connected to the internet, a wireless hand held device, a digital television set, etc.

An exemplary system for providing personalized weather reports in accordance with the present invention includes a main computer system. The main computer system may include a weather forecast modeling functionality for calculating and presenting high geographical and temporal resolution forecast data. The main computer system may also receive weather information from one or more weather information sources, e.g., NEXRAD weather radar information provided by the government, local live weather radar information, and other weather information from local and/or remote sensors. NEXRAD weather radar information includes detailed storm attribute information describing the characteristics of storm cells. The NEXRAD storm attribute information also includes information on the direction and speed of movement of storm cells, from which a predicted track of these storms may be generated. The main computer system includes software for generating a predicted storm track from such NEXRAD data, or, more preferably, from NEXRAD data in combination with local live radar information. The local live radar information, which is less detailed, but which provides updated storm cell positions much more often than NEXRAD information, may be used in combination with NEXRAD information to enhance the accuracy of the predicted storm cell tracks.

The main computer system may also include a user profile generator. The user profile generator provides various user profile set-up menu user interfaces which allow a user to establish a user profile. These menus may be accessed by a user by use of, for example, a personal computer connected to the main system computer over a network such as the internet. Using such menus, a user establishes a personal user profile which includes a particular location of interest, e.g., home, vacation home, or work, for which the user would like detailed weather information, and, optionally, a personalized activity weather condition profile, establishing a preferred weather condition profile for activities of interest to the user. The high resolution forecast model is run to obtain forecast data that is compared to the user profiles saved in the user profile database and personalized weather report forecast information is generated automatically by a personalized report generator implemented in the main computer system.

In a similar manner, the set-up menu user interface may also allow a user to define a storm profile, including storm attribute conditions for which the user would like a personalized storm warning to be provided, and the amount of advanced warning (e.g., based on predicted storm cell arrival time at the user location of interest, or the distance of a storm cell from the user location of interest) which the personalized storm warning is to provide. Storm profile information thus obtained is stored in the user profile data base. Each time a storm track is generated or updated, the resulting storm track data is compared to the user profiles saved in the user profile database, and personalized storm warning information is generated automatically by a storm warning generator implemented in the main computer system. Personalized storm warning information is generated for each user location of interest which falls within a projected storm track, if the storm attribute characteristics and advanced warning limitations established by the user in the storm profile are satisfied by the characteristics of the generated storm track.

The set-up menu user interface may also allow the user to select from among several different presenters that may be animated by the system to present personalized weather information to the users. The user may be allowed to select from among different voice and/or physical characteristics of the selected presenter.

The personalized weather report forecast information and/or personalized storm warning information, as the case may be, constitute the personalized weather information to be presented to the individual user. This personalized weather information is used to derive a personalized weather information presentation in the form of a text or other data file. The personalized weather information presentation represents in substance, if not in form, the script for the audio portion of a presentation of the personalized weather information by an animated presenter in accordance with the present invention. The personalized weather information presentation may be generated automatically using appropriate pre-generated phrases and the like that are selected based on the content of the personalized weather information and that are populated with specific weather information from the personalized weather information.

The personalized weather information presentation text or other data file may be employed, in combination with any user selections for the animated presenter's voice characteristics, using a text-to-speech generator, or the like, to generate an audio data file for the audio portion of the animated weather report presentation to be provided to a user. Preferably the audio rendering thus created reflects not only the specific text of the personalized weather information but also the substantive meaning of the personalized weather information to the user. For example, the tone, volume, or other characteristic of the audio presentation preferably is varied automatically based on the underlying personalized weather information content, e.g., to present a tone of urgency if a storm is approaching or of happiness if the weather forecast is sunny and mild.

The personalized weather information presentation text or other data file, or the corresponding audio file, along with any user selections regarding the visual characteristics of the animated presenter, is also used to drive the animation of the animated presenter. The animated presenter preferably is animated such that mouth and facial movements and the like correspond realistically to the words being annunciated in the audio portion of the presentation. The animated presenter preferably is also animated such that the underlying substantive meaning of the weather information being presented is reflected in the animated presenter's facial and other movements, e.g., smiling when presenting a sunny and mild forecast but not when reporting an oncoming storm.

A personalized weather information presentation by an animated presenter, including both audio and visual portions thereof, may be provided to a user via any addressable device capable of presenting such audio/video media. For example, such a presentation may be provided via the internet to a user's personal computer, to a wireless hand-held device, to an addressable digital television, or the like.

Further objects, features, and advantages of the present invention will be apparent from the following detailed description of the present invention taken in conjunction with the accompanying drawings.

### BRIEF DESCRIPTION OF THE DRAWINGS

FIGS. 1 and 2 are a schematic block diagram of an exemplary system for providing personalized weather report and storm warning presentations by an animated user in accordance with the present invention.

FIG. 3 is a schematic flowchart diagram of an exemplary method for providing personalized weather forecast information in accordance with the present invention.

FIG. 4 is an exemplary user profile set-up menu user interface for use in a system and method for providing personalized weather forecast information in accordance with the present invention.

FIGS. 5a and 5b is an exemplary outdoor activity weather condition profile set-up menu user interface for use in a system and method for providing personalized weather forecast information in accordance with the present invention.

FIG. 6 is a schematic flow chart diagram of an exemplary method for providing personalized storm warning information in accordance with the present invention.

FIG. 7 is a exemplary user profile set-up menu user interface for use in a system and method for providing personalized storm warning information in accordance with the present invention.

FIG. 8 is a schematic illustration of a storm track in relation to individual user locations of interest for which personalized storm warnings in accordance with the present invention are to be provided.

FIG. 9 is an exemplary user profile set-up menu user interface for use in selecting visual and audio characteristics of an animated presenter in a system and method for presenting personalized weather information by an animated presenter in accordance with the present invention.

FIG. 10 is a flow chart diagram of an exemplary method for generating a presentation of personalized weather information by an animated presenter in accordance with the present invention.

### DETAILED DESCRIPTION OF THE INVENTION

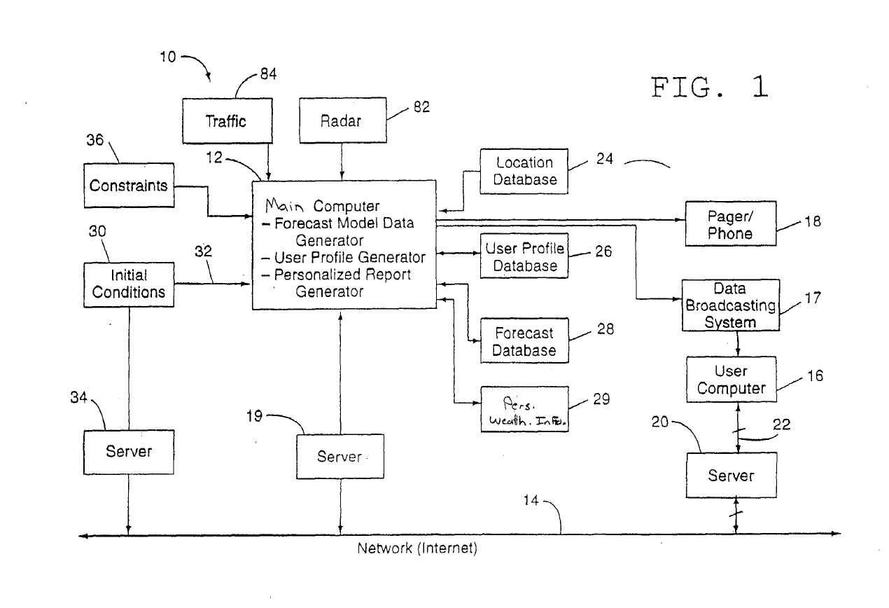

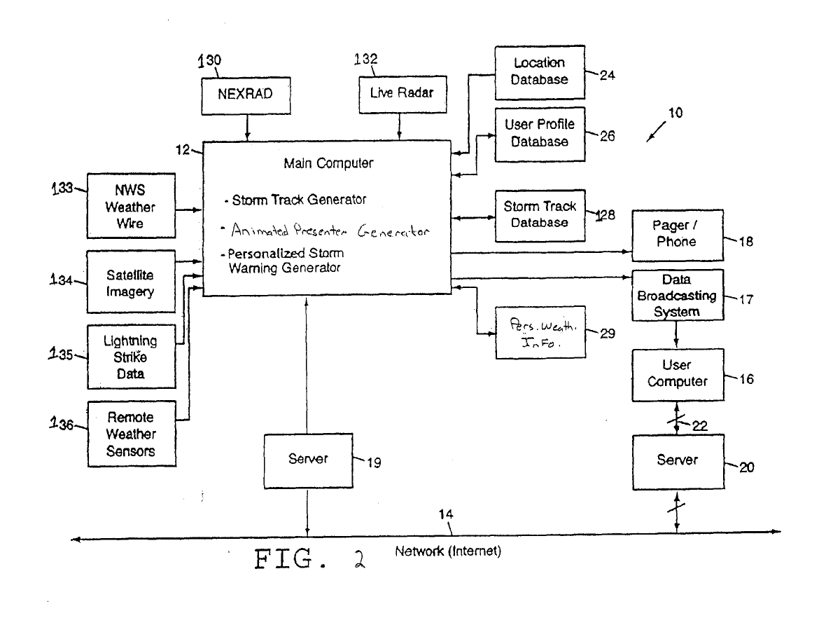

A schematic block diagram or an exemplary system 10 for providing personalized weather report and storm warning presentations by an animated presenter in accordance with the present invention is illustrated in, and will be described in detail with reference to, FIGS. 1 and 2. In accordance with the present invention, personalized weather reports and storm warning presentations, and the like, are generated by a main computer system 12 which communicates, e.g., via a network connection 14, with a user's computer 16. The main computer system 12 may be implemented as one or more conventional computers. The user's computer 16 may be implemented in a conventional manner as a personal or handheld wireless computer, Web TV terminal, digital television system, or the like. Two-way communications between the main computer system 12 and the user's computer 16 may be provided over any suitable communications network or link 14. Alternatively, communications between the main computer 12 and the user's computer 16 may be via any known or future data broadcasting system 17. The main computer 12 may also be in communication with a user's cellular or other telephone 18 or other wireless device, for providing personalized weather report and storm warning presentations in accordance with the present invention to the user thereby, as will be discussed in more detail below.

Preferably, and conveniently, the main computer system 12 and the user's computer 16 may communicate with each other via the internet 14, using conventional and widely known internet communications formats, protocols, etc. The main computer system 12 and user's computer 16 may be connected to the internet 14 in a conventional manner via servers 19 and 20, respectively. Note that the server 19 providing an internet connection for the main computer system 12 may be separate from or an integral part of the main computer system 12. The server 20 providing an internet connection for the user computer 16 may typically be provided by a commercial internet service provider. Communications between the user's computer 16 and the internet service provider's server 20 may typically be accomplished using a modem connection for communication over conventional telephone lines, cable television lines, or other physical or radio links 22. It should be understood that the central computer system 12 may provide personalized weather reports to many user computers 16 connected to the main computer system 12 over the internet 14. For example, a single internet service provider's server 20 may provide a connection to the central computer 12 over the internet 14 for many user computers 16, and an essentially unlimited number of servers 20 may be on the internet 14.

As mentioned above, the main computer system 12 may be implemented in a conventional manner using a single computer or multiple computers networked together to perform the functions required. The main computer system 12 may include conventional computer peripheral devices (not shown), including input and output devices such as keyboards, mouses, monitors, printers, etc. The main computer system 12 will also include conventional computer memory devices, including disk or tape storage devices for storing the computer programs which will be run on the main computer system 12 to implement a method for providing personalized weather reports and storm warnings and the like via an animated presenter in accordance with the present invention. Memory, e.g., disk storage space, etc., is also provided for the storage of databases of information which is employed by the programs running on the main computer system 12 for generating personalized weather reports and storm warnings and the like. Such databases include a geographic location database 24, a user profile database 26, a weather forecast database 28, and a storm track database 128 (FIG. 2). The use of each of these databases 24, 26, 28, and 128 in generating a personalized weather report or storm warning presentation in accordance with the present invention will be described in detail below. It should be noted that information in each database 24, 26, 28, and 128 may be stored in its own memory device, e.g., disk, or together on the same disk or other memory device. Memory capacity 29 is preferably also provided for storing personalized weather report and storm warning presenter information (generically referred to as personalized weather information) generated by the computer 12 and used to generate personalized weather information presentations by animated weather presenters, as will be described in more detail below.

The main computer system 12 is preferably adapted to receive weather information from a variety of sources, from which accurate storm tracks may be generated (see FIG. 2). Such sources of weather information may include NEXRAD weather radar information 130, as well as live radar data 132. NEXRAD weather data 130 is provided by the government. NEXRAD information 130 includes a storm attributes table which defines storm cells and provides detailed information concerning the cells, including the characteristics of the cells (e.g., hail and vortex intensity and location, rain fall intensity, speed, etc.), as well as the position, direction, and speed of movement of the cells. NEXRAD data is obtained from a volumetric scan of the atmosphere, and is provided to the main computer system 12 on a periodic basis, e.g., approximately every six minutes.

Live radar data 132 may be provided to the main computer system 12 from one or more local or remotely located radar systems. Live radar data 132 preferably provides real time radar sweep information to the main computer system 12 much more often than NEXRAD information is provided to the system 12. For example, a conventional radar sweep may generally be completed in 30 seconds to 90 seconds. If the live radar 132 is operating to scan only a selected sector of interest, live radar information for the sector may be provided as often as every 10 seconds. Although NEXRAD 130 and live radar 132 are both radar sources, NEXRAD information is provided from much more expensive and powerful radars and information processing systems than conventional live radar. Thus, NEXRAD radar information is much more detailed, but less timely than live radar information.

Other sources of weather information which may be provided to the main computer system 12 include National Weather Service weather wire information 133, including weather warning bulletins authored by the National Weather Service Storm Prediction Center, and other related government agencies, as well as satellite imagery 134, including high resolution visible and infrared satellite imagery. Live lightening strike data 135, and readings from remote weather sensors 136, providing, e.g., live wind speed and other live weather information, may also be provided to the main computer system 12. As will be discussed in more detail below, detailed and accurate storm tracks may be generated from NEXRAD information alone, or, preferably, from NEXRAD information in combination with other weather information, such as live radar information.

The main computer system 12 may receive NEXRAD data from multiple NEXRAD sites. The storm data received from such multiple sites may overlap. For example, data for a single storm cell may appear in NEXRAD storm attributes tables from more than one site. Often, the storm attribute data for a single storm cell provided from different sites may not be identical. In such a case, the main computer 12 preferably selects the attributes which are likely to be most accurate for a particular storm cell for use in generating storm tracks in accordance with the present invention. For example, the computer 12 may automatically select information for a particular storm cell from a NEXRAD site which indicates the greatest storm intensity, or some other user selected characteristic, or combination of characteristics, for the cell. If information for a particular storm cell from more than one NEXRAD site indicates the same intensity, or other characteristics, for the storm cell, the information from the NEXRAD site nearest to the storm may be selected. Any other method for selecting the storm cell attributes for a particular storm cell for which storm cell attributes are being provided by more than one NEXRAD site may be employed.

In accordance with the present invention, the main computer system 12 is programmed, using conventional programming techniques, to perform various functions to provide personalized weather information presentations to users. Such functions to be performed by the main computer 12 include (see FIG. 1) a weather forecast model data generator function, a user profile generator function, a personalized weather forecast information generator function and (see FIG. 2) a storm track generator function, a personalized storm warning generator function, and a animated presenter generating function. Each of these functions will be described in more detail below.

Any conventional commercially available weather forecasting model may be employed in the main computer system 12 to implement the weather forecast model data generator function. Such models typically generate modeled weather forecast data based on atmospheric condition initialization data. Preferably, the weather forecasting model employed is capable of providing highly detailed and accurate weather forecasts of various weather parameters of interest, e.g., temperature, sky conditions, winds, precipitation, etc., with a high degree of both geographical and temporal resolution. An example of such a preferred weather forecasting model is the ADONIS model, available from Weather Central, Inc., of Madison, Wis. This non-hydrostatic model is capable of providing accurate and detailed forecast weather parameters for geographical areas a few miles across at half-hour increments for at least 120 half-hour periods into the future. (The degree of geographic and temporal resolution is user adjustable, and may be provided over longer or shorter time periods.) Based on calculated forecast weather parameters for discrete closely spaced points in a geographic area, the model automatically and accurately extrapolates forecast weather conditions for any lat./lon. coordinate within the modeled area.

The commercially available ADONIS Microcast weather forecast modeling product available from Weather Central, Inc., of Madison, Wis. is capable of providing the same high geographic and temporal resolution weather forecast data produced by ADONIS, as described above. This model employs initial atmospheric condition data 30 which is computed at a central location from “raw” observational data provided by the National Weather Service and other agencies. The initialization data 30 is provided periodically, e.g., twice a day, from the central location to the main computer system 12. The initial conditions 30 may be provided to the main computer system 12 running the weather forecasting model via a direct communication link 32 (e.g., a satellite link) or, alternatively, via the internet 14, via a server 34, in either case using conventional data transfer protocols.

The detailed high resolution weather forecast model data generated by the forecasting model employed in the computer system 12 may be subject to constraints, provided via a constrainer module 36, before such model data is employed to generate a personalized weather report information in accordance with the present invention. The constraints 36 may be provided to the computer system in a variety of ways. For example, constraints 36 may be provided to the computer system 12 directly, such as by a meteorologist or other operator entering such constraints directly into the computer system 12 via a keyboard or other input device associated therewith. Alternatively, or additionally, constraints 36 may be provided to the computer system 12 from a remote location, e.g., via a direct communications link (e.g., a satellite link) or via the internet 14 or another communications network. Constraints 36 may be applied to any modeled weather condition, e.g., temperature, wind speed, precipitation, etc., and may be applied throughout an entire modeled geographic area, or to selected portions thereof. The constraints 36 limit the modeled weather conditions which are used to generate personalized weather reports in accordance with the present invention to enhance the accuracy of such reports. For example, a meteorologist may determine, based on experience and/or information which is not available to the model employed, that, for example, the high temperature or precipitation for a modeled region and time will not exceed certain levels. Such limits may be provided to the computer system 12 as constraints 36, to ensure that no personalized weather report for locations within such region forecasts predicted temperatures or precipitation exceeding the constrained levels.

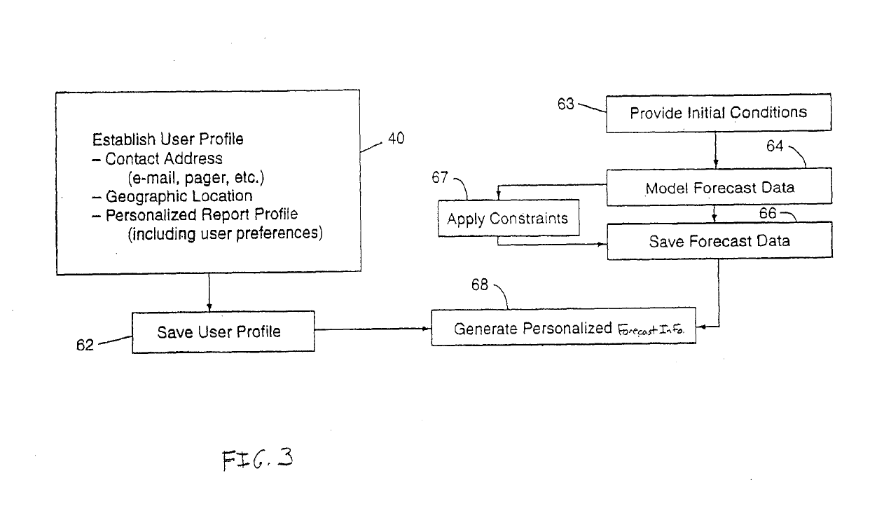

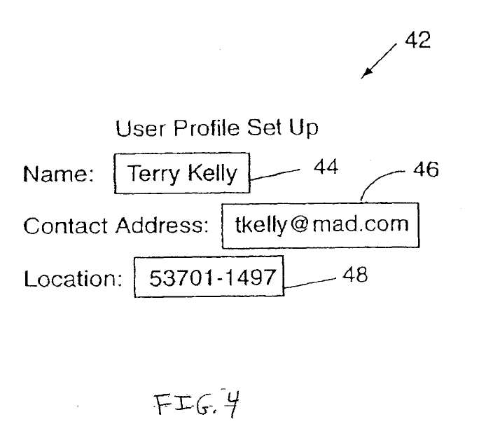

An exemplary method, employing the system 10 described with reference to FIG. 1, for providing personalized weather report forecast information will now be described in detail with reference to the exemplary flowchart diagram of FIG. 3. A more detailed description of a system and method for providing personalized weather report forecast information is provided in U.S. Pat. Nos. 6,498,987, 6,823,263, and 7,058,510, all entitled System and Method for Providing Personalized Weather Reports and the Like, the details of which are incorporated herein by reference. The process of providing personalized weather report forecast information begins with the establishment of a user profile 40. The user profile may be established by each user himself. For example, a user may establish a user profile by connecting with the main computer system 12 over, e.g., the internet 14. The user profile generator function, running on the main computer system 12, may preferably provide a user profile set-up menu user interface as a web page which may be accessed by the user over the internet. An exemplary, and very simplified, user profile set-up menu user interface is illustrated at 42 in FIG. 4. The user profile set up menu user interface 42 prompts a user to provide a name 44, contact address 46, and location identification 48. (The user profile set-up menu user interface 42 may also prompt the user to provide other information, e.g., billing, e.g., credit card, information for billing the cost of personalized weather reports to the user, in a conventional manner. The page on which the user profile set-up menu user interface 42 is provided may also include advertisements and hypertext links to other web pages or sites on the internet, in a conventional manner.)

The location 48 is the geographical location for which the user is interested in receiving detailed weather information. For example, the location may be the user's home or work location, or the location of business activity, such as a construction site. Various methods may be used for identifying the desired location. For example, the user may provide a street address or a United States Postal Service zip+4 code, either of which will identify the location of interest with sufficient detail. In this case, since the weather forecast model run on the main computer system 12 will typically produce weather forecast data for geographic locations identified by lat./lon. coordinates, it will typically be necessary to convert the location 48 entered by the user in the user profile set-up menu user interface 42 into a lat./lon. coordinate. For this purpose, the main computer system 12 may employ a geographic location database 24, which may include a table or other data structure for converting street addresses, zip+4 codes, etc. to corresponding lat./lon. coordinates. Alternatively the user location of interest may be provided automatically and dynamically to the system 12 by the user. For example, the known location of a digital television receiver to which a personalized weather presentation is to be delivered may be provided automatically to the system 10 as the user location of interest 48. Alternatively, a hand held or other device associated with the user and having a built in GPS or other geo-location system may be used to provide a current and periodically or continuously updated location of interest 48 to the system 10.

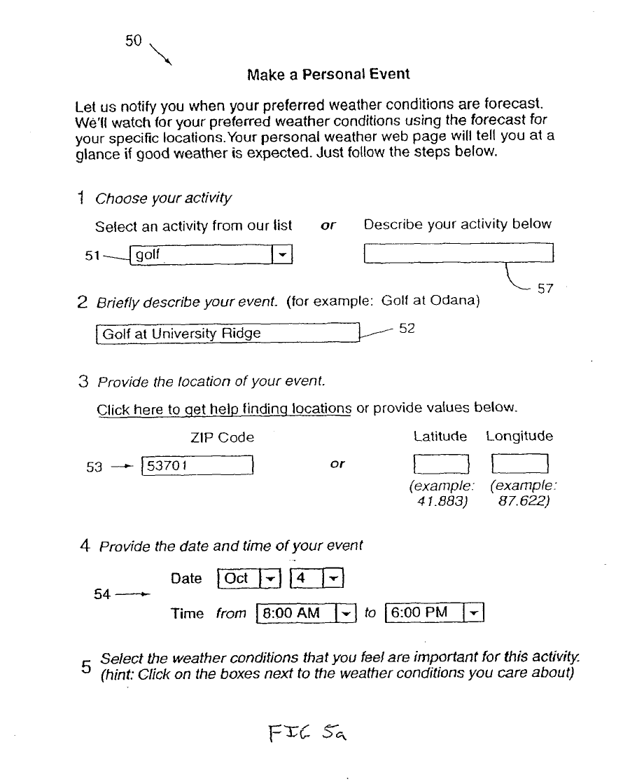

Preferably, a user may also be prompted to identify outdoor or other activities in which the user is interested and for which the user would like advance notice of favorable (or unfavorable) weather conditions. An exemplary user activity weather condition profile set-up menu, which may be generated by the user profile generator, is illustrated at 50 in FIG. 5. The user may be provided with a predefined list 51 of typical outdoor activities from which to select. Having selected one or more activities from the activity list 51, the user is prompted to provide a label 52 describing the particular activity/event of interest The user is then prompted to select a desired location 53 or locations for performing the activity. The menu 50 may prompt a user to select a location from a selection of locations previously stored in the system, such as a golf course or courses at which the user is interested in playing, or may require the user specifically to identify the activity location of interest, e.g., by postal code or latitude and longitude, as described above. The geographical location database 24 preferably includes lat./lon. coordinates for activity locations, e.g., golf courses, lakes for fishing, beaches for wind surfing, etc., which may be selected by a user, such that the main computer system 12 may convert such locations to lat./lon. coordinates, as discussed above. The user may be prompted to select desired days and times 54 for the activities of interest. Finally, the user is prompted to select weather conditions (e.g., temperatures, sky conditions, humidity, precipitation, wind speed and wind direction) of interest for such activities, and ideal ranges for such conditions. If a weather condition is selected as being of interest, e.g., by selecting a check box 55 next to the condition in the menu 50, the ranges 56 identified for that condition will be considered in determining if a user weather condition activity profile has been satisfied. (Unselected conditions are always considered satisfied.) Of course, the user may be prompted to provide different or other conditions than those illustrated by example in FIG. 5. The profile weather conditions which a user may be prompted to select may depend on the activity of interest for which a weather condition profile is to be generated. The activity weather condition profile user interface may provide default values for some or all of the conditions, based on, e.g., weather conditions for the activity which are preferred by most or typical participants in the activity, while providing an individual user the opportunity to override the default condition values to establish his or her own preferred weather condition profile. For activities for which a user desires to receive advance notice of favorable (or unfavorable) conditions, but which are not listed in the predefined selected activities list 51, the user may describe another activity 57 and select a location 53, time 54, and ranges 56 of selected conditions 55 for conditions modeled by the weather forecast model to establish a personalized activity weather condition profile. Such other activities may include business activities, allowing a user to define a profile of desired business conditions, for example, for pouring concrete or erecting a crane at a designated construction location. The user activity weather condition profile set-up menu 50 preferably also provides a user interface 58 which allows a user to activate a profile which has been defined using the set-up menu 50, to delete a profile, or to reset the information entered into the menu 50 to default values.

Having established a user profile, using the user profile set-up 42 and related user interface menus, the user profile is saved 62 by the main computer system 12, e.g., in a user profile database 26. Of course, many individual user profiles may be established by individual users and saved by the main computer system 12 in the user profile database 26. A user is preferably able to change any user definable portion of his user profile at any time by re-accessing the user interface menus 42 and 50, e.g., over the interne connection 14, and making any desired changes. For security purposes, a user may be requested to establish a user password upon initially establishing a user profile, and may be prompted to enter this password before being allowed to make any changes to a previously established user profile.

Periodically, e.g., twice a day, the main computer system 12 runs 64 the weather forecasting model, as described above, to provide detailed accurate high resolution weather forecast data. As discussed above, depending upon the model employed, the weather forecast model may require initial conditions 30 to be provided thereto 63. For example, initial conditions may be provided to the computer system 12, e.g., twice a day, from a remote central location, and the weather forecast model run 64 each time the initial conditions are provided. The resulting detailed high resolution weather forecast model data is saved by the main computer system 12 into a forecast database 28 at 66. As discussed above, the detailed weather forecast data includes detailed weather condition information, e.g., temperatures, sky conditions, winds, precipitation, etc., for specific geographic locations (preferably no more than a few miles apart) and with a high degree of temporal resolution (e.g., for half-hour increments) extending up to several days into the future. If any constraints 36 on the forecast model data have been previously provided to the computer system 12, such constraints are preferably applied at 67 to the model forecast data 64 before the forecast data is saved 66. Thus, constrained modeled forecast data is saved 66 and employed to generate personalized weather forecast information accordance with the present invention.

The saved weather forecast data from the forecast database 28 is combined by the personalized report generator function in main computer system 12 with the user profile data in the user profile database 26 at 68 to generate personalized weather report forecast information for each user who has established a user profile. The step 68 of generating personalized weather report forecast information may be performed automatically, for example, each time the weather forecast model is run to generate weather forecast data.

If a user has established a weather condition profile for one or more activities, such profiles may be compared to the saved forecast data by the personalized weather report generator as part of the step of generating personalized weather report forecast information. If forecast conditions for the indicated activity location satisfy the established profile an appropriate indication is made in the personalized weather forecast information.

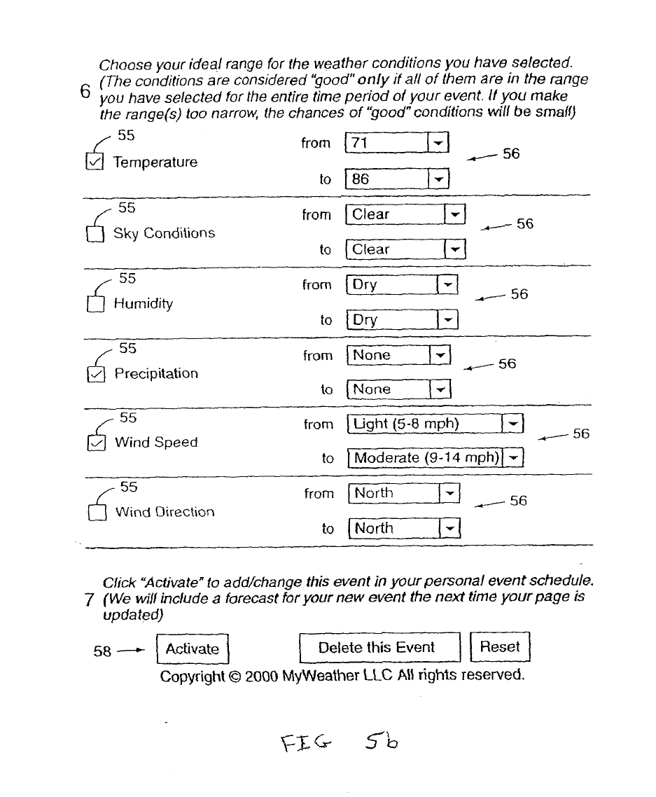

An exemplary method, employing the system 10 described with reference to FIG. 2, for providing personalized storm warning information, will now be describe in detail with reference to the exemplary flow chart diagram of FIG. 6.

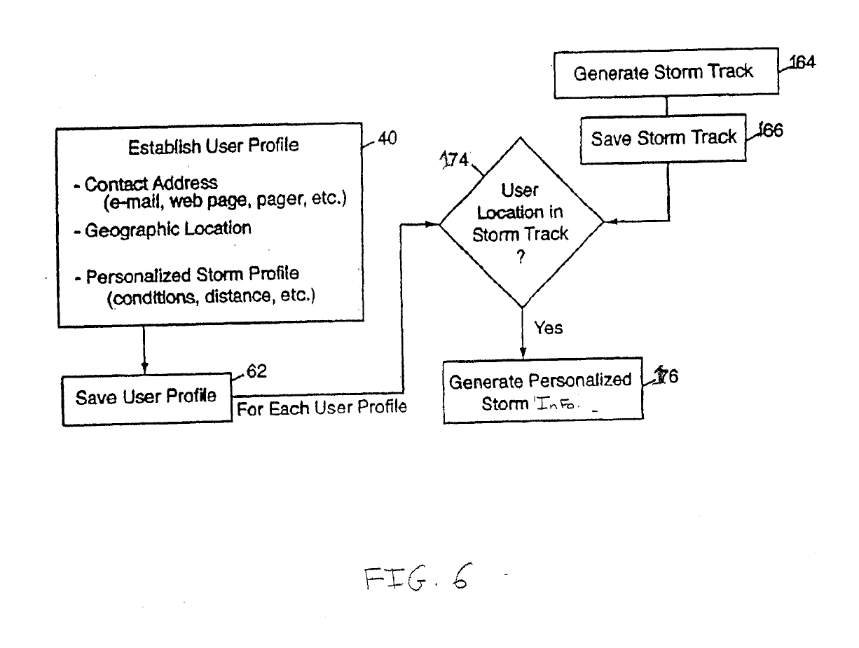

For obtaining personalized storm warning information the user profile set up menu 42, as illustrated by example in FIG. 7, preferably prompts the user to establish a storm profile, which defines the characteristics of storms for which the user desires a personalized storm warning to be provided. The storm profile, which may be established by the user using the user profile set-up menu user interface 42, may include both storm attribute characteristics, i.e., the severe weather conditions of a storm, as well as the amount of advanced warning with which a user desires a personalized storm warning to be provided. For example, a user may be prompted to select from several severe weather attributes which are characteristic of a storm. A list of severe weather attribute characteristics 150, e.g., tornado, hail, heavy rain, etc., may be listed on the user profile set-up menu user interface 142, with a check box 152 next to each attribute characteristic listed. By selecting a check box 152 next to a particular storm attribute characteristic, a user indicates that he only wishes a personalized storm warning to be provided if a storm approaching the user location of interest includes the severe weather storm attribute characteristics indicated. The user may also be prompted to select a degree of a particular storm attribute characteristic of a storm. For example, if a user is interested in receiving a personalized storm warning for storms including hail, the user may also be prompted to select a minimum hail size 154. Thus, a personalized a storm warning would only be provided, in such a case, if a storm approaching the user's location of interest includes hail, and if the hail is at least of the size indicated 154. A user may also be prompted to select a minimum probability that a particular storm attribute characteristic is present in a storm approaching the user's location of interest. For example, a user may employ the user profile set-up menu user interface 42 to indicate that he is interested in receiving a personalized storm warning only if the percentage likelihood of a particular storm attribute characteristic in a storm approaching his location of interest is at least a certain percentage (e.g., the percentage likelihood of a tornado in a storm approaching his location of interest is at least 25 percent, and the percentage likelihood of the presence of hail, having a size of at least a half-inch, is at least 75 percent). Of course, it should be understood that various storm attribute characteristics, degrees of such attribute characteristics, and probabilities of the presence of such attribute characteristics other than those illustrated by example in FIG. 7 may be made available for selection by a user in a user profile set-up menu user interface 42. The storm characteristics, degrees thereof, and probabilities of the presence thereof, which are made available for selection by a user will depend on the attribute characteristics of a storm which can be obtained from available weather information sources (e.g., NEXRAD 130, live radar 132, satellite imagery 134, lightening strike data 135, and live weather information from remote weather sensors 136) which are used by the main computer system 12 to track the storm. Thus, for example, a user may indicate in the storm profile that he is interested in receiving a personalized storm warning if lightening strikes are detected near the user's location of interest, if lightening strike data 135 is available to the main computer 12.

The user profile set-up menu user interface 42 may also prompt a user to indicate an advanced warning time or distance condition 156. The advanced warning time or distance condition 156, selected by a user, defines a predicted time from arrival at the designated user location of interest of a storm, or a current distance from the designated user location of interest of a storm, for which the user desires a personalized storm warning to be provided. A personalized storm warning may, therefore, be provided to a user only if the predicted arrival time of a storm at the user's location of interest is less than or equal to the indicated advanced warning time condition, or the current location of the storm is less than or equal to the advanced warning distance condition. The user may select between an advanced warning time or distance condition by selecting an appropriate check box 158 on the user profile set-up menu user interface 42. The user then specifies the specific advanced warning time or distance condition desired 160.

As discussed above, having established a user profile, using the user profile set-up menu user interface 42, the user profile is saved 62 by the main computer system 12, e.g., in a user profile database 26. Of course, many individual user profiles may be established by individual users and saved by the main computer system 12 in the user profile database 26. A user is preferably able to change any user definable portion of his user profile at any time by re-accessing the user interface menu 42, e.g., over the Internet connection 14, and making any desired changes. For security purposes, a user may be requested to establish a user password upon initially establishing a user profile, and may be prompted to enter this password before being allowed to make any changes to a previously established user profile.

Periodically, or continuously, the main computer system 12 runs a storm tracking algorithm to generate storm tracks 164. The storm tracks generated preferably include detailed information concerning attribute characteristics of a storm (e.g., tornadic activity, hail, heavy precipitation, etc.) as well as the current location of the storm and a predicted path of the storm. Such a storm track may be generated using various known methods, using various different forms of weather information, e.g., weather information provided by NEXRAD 130, live radar 132, and other weather information services.

As discussed above, NEXRAD provides detailed information on the location, direction, speed, and other characteristics of a storm cell. Such data is updated approximately every 6 minutes. Therefore, for a system which generates storm tracks 164 exclusively from NEXRAD information 30, the step of generating storm tracks may be performed each time updated NEXRAD information 130 is received. Preferably, however, the positions of tracked storms are updated more frequently, i.e., between each receipt of new NEXRAD information, to provide a more accurate indication of storm position. Such updates may be based on the latest available NEXRAD information itself. For example, storm cell attributes, positions, and tracks may be advanced periodically between NEXRAD updates based on the storm heading and speed information provided in the most recent NEXRAD update.

During the time period between NEXRAD updates, however, the direction and speed of a storm cell can change significantly. This is particularly true for rapidly developing storm cells, for which accurate information concerning direction and speed of movement of the storm cell is most critical. Thus, a position and track of NEXRAD storm attributes based on NEXRAD data alone, even if updated periodically between NEXRAD updates, may become increasingly inaccurate as the time since the last NEXRAD update was provided increases. Therefore, the position and predicted track of detailed NEXRAD storm cell attributes is preferably updated between NEXRAD data updates by integrating the detailed storm cell information provided by NEXRAD 130 with live radar data 132 from local or remote radar sites. As discussed above, live radar scans can provide updated position information on storm cells at a rate of up to every 10 (for sector scans) to 90 seconds. A preferred method for updating the position and predicted track of NEXRAD storm cell attributes based on live radar information is described in detail in U.S. Pat. No. 6,339,747, entitled “Weather Tracking and Display System and Method”. The location of intensities and other characteristics of a storm cell provided in a NEXRAD storm attributes table may be advanced along a predicted line using the speed and direction of movement of the storm cell as determined from a live radar source 132 which is being fed to the storm track generator function running in the main computer system 12. This is achieved by linking or correlating a storm cell being tracked by live radar with the same storm cell as identified in the latest available NEXRAD information. Preferably, each time a live radar 132 scans a weather cell, the new location of the weather cell attributes defined by NEXRAD may be determined. A new storm track is then generated, extending from the updated location, using the attributes for the storm cell as provided by the NEXRAD storm attributes table, but starting from the new location determined by the live radar data, or using new speed and heading information determined from the live radar data. This updating may continue with each sweep of the live radar. Therefore, the step of generating storm tracks 164 may be performed substantially continuously, e.g., each time a storm cell is scanned by a live radar 132. When the next NEXRAD radar update is received, the attributes of the storm cell are updated, and the NEXRAD defined storm cell re-linked or correlated to the corresponding storm cell in live radar data. Thus, improved accurate tracking of detailed storm cell information may be provided using integrated NEXRAD and live radar data.

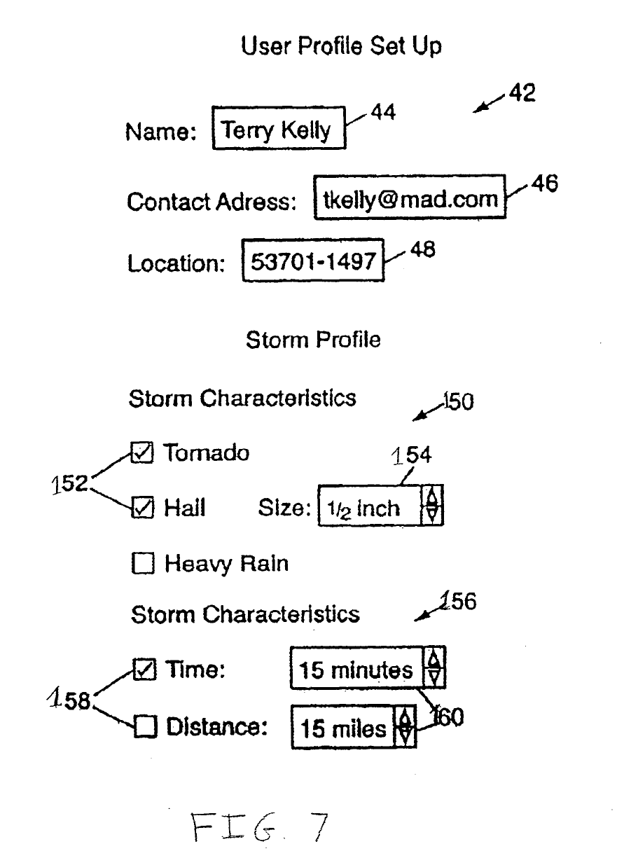

Detailed storm track information, however generated, is saved by the main computer system 12 into a storm track database 128 at 166. Saved storm track data from the storm track database 128 is combined with the user profile data in the user profile database 26 to generate personalize storm warning information for each user who has established a user profile. User profiles for many individual users will define many individual locations of interest for which users are interested in receiving personalized storm warnings. However, the storm tracks, if any, generated by the main computer system 12 may typically only affect a few of the thus-defined user locations of interest. For example, FIG. 8 illustrates, schematically, a storm cell 168, for which a position, storm cell characteristics and a track, in the form of a tracking wedge 170, indicating predicted movement of the storm cell 168, has been generated by the main computer system 12 based on current weather radar information. (It should be noted that the storm cell track may be generated in forms other than a tracking wedge 170.) User locations of interest 172, defined by individual users in their respective user profiles, are also indicated in FIG. 8, relative to the storm cell 168 and track 170. Note that typically only a few of the user locations of interest 172A are located within a storm cell 168 or predicted track 170. Thus, it is only necessary to generate personalized storm warnings in accordance with the present invention for those user locations of interest 172A located within the storm cell 168 or track 170. Therefore, the main computer system 12 preferably first combines the storm track data saved in the storm track database 128 with the user profile information stored in the user profile database 26 to determine 174, for each user profile, whether the user location of interest identified in the user profile is located within a detected storm cell 168 or track 170.

If a user location of interest is determined at 174 to be within a generated storm track, personalized storm warning information is generated by the main computer system 12 for that specified user location at 176. Note that the steps of determining whether a user designated location of interest is within a storm track, and generating personalized storm warning information therefore, may be performed automatically, for example, each time a new storm track is generated or updated by the storm track generator function of the main computer system 12.

The step 176 of generating a personalized storm warning may also include the step of comparing generated storm tracks, saved in the storm track database 28, with user defined storm profiles, saved in the user profile database 26, to determine if storms affecting individual user locations of interest also satisfy the storm profile conditions established by the user. Personalized storm warning information need only be generated and provided to a user if the storm affecting a user location of interest satisfies the storm profile conditions established by the user for that location of interest, i.e., if the tracked storm includes the storm attribute characteristics established by the user, and if the predicted arrival time of the storm at the user's location of interest, or the current distance of the storm from the user's location of interest, satisfies the advanced warning conditions established by the user in the storm profile. If the storm profile conditions are satisfied, personalized storm warning information is generated for the user location of interest. Thus, a user is only provided with storm warnings for storms which affect the user's particular location of interest and which include storm attribute characteristics which are of interest to the user. Also, a personalized storm warning is provided to the user to provide a degree of advanced warning as selected by the user. Additional filtering, checking, or other functions may be performed to verify the appropriateness of generating a personalized storm warning information in accordance with the present invention. For example, where multiple storms are approaching a user location of interest, multiple storm warnings may be included in a single personalized storm warning.

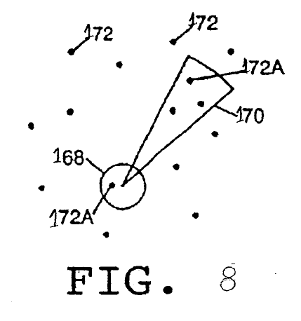

In accordance with the present invention, a user may select the visual and/or audio characteristics of the presenter that is to be animated to present personalized weather information to the user. The user may be prompted by the user profile set-up menu 42 to make such a selection. For example, as illustrated in FIG. 9, the user may be prompted to select a check box 200 to indicate the visual characteristics of the presenter. Thumbnail images 202 of the available visual characteristic options may be provided. The user may be prompted to select a check box 204 to select the audio characteristics of the presenter. Links 206 to sample audio clips of the available audio options preferably are provided.

It should be noted that the visual and audio characteristics of the presenter made available to the user may vary based upon the computing power available, expense of implementation, and other factors. The presenter may be rendered in simple “cartoon” style, at one end of the spectrum, or as a highly detailed and realistic animation based on digitized images of an actual person. In the later case, for example, digitized and animated images of a local weather reporter or other known personality may be used to provide the personalized weather report presentation in accordance with the present invention.

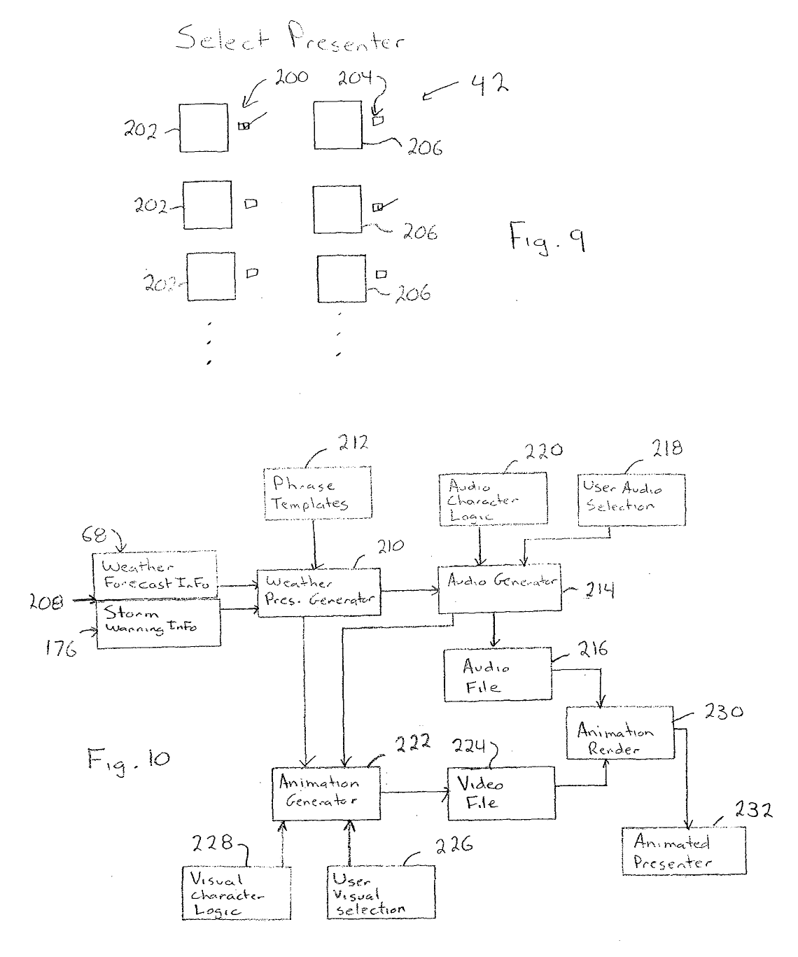

An exemplary method for generating a personalized weather forecast report and or warning presentation via an animated presenter will now be described with reference to FIG. 10. Personalized weather forecast information 68 and/or personalized storm warning information 176 are generated for a user as described above. This information will be referred to generally as personalized weather information 208.

The personalized weather information 208 is provided to a weather presentation generator 210. The weather presentation generator 210 generates essentially a script for the animated weather presenter. That is, the weather presentation generator 210 generates the phrases that form the weather presentation and that are to be delivered by the animated weather presenter. The weather presentation generator may generate such phrases by using pre-generated and phrase templates that cover all possible weather conditions that may be reported. Depending upon the personalized weather information 208 to be presented appropriate phrase templates are selected and populated with specific weather information from the personalized weather information. For example, if the personalized weather information indicates that rain is predicted for a user specified location of interest the following phrase template may be selected: “Rain is going to start to fall at [user location of interest] at [time rain is forecast to start] and you will see a total rain fall of [forecast accumulated rainfall] by the end of the day.” The specific information to complete the sentence is pulled from the weather forecast information 208 and, in this case, the user profile information. Multiple pre-generated phrases for the same weather conditions should be provided and selected randomly or in some pattern to provide more realistic presentations. A weather reporter would not use the exact same words each time to report the same weather.

The weather presentation generator 210 generates a text or other data file that is used by an audio generator 214 to generate the audio portion of the weather information presentation that is stored in an audio file 216. For example, the audio generator 214 may be implemented as commercially available text-to-speech generator or other commercially available product to implement this function. The characteristics of the audio generated by the audio generator 214 is preferably based on the user audio characteristic selection 218, if any. Preferably the characteristics of the audio are also based on the substantive content of the weather information to presented to create a more realistic audio presentation. Audio character logic 220 may be used to analyze the contents of the weather presentation information 208 to determine appropriate audio characteristics. For example, if the audio character logic 220 determines that the weather presentation information includes a severe weather warning the audio generator may generate audio to be delivered in a more serious tone.

An animation generator 222 is used to generate the video image portion of the animated presenter presentation that is saved in a video data file 224. The video image may be generated by the animation generator 222 based on the weather presentation information from the weather presentation generator and/or the audio data from the audio generator 214 depending upon the animation generator 222. A commercially available animation generator 222 may be used for this purpose. The animation generated is also based on the user selected visual characteristics 226 of the animated presenter, if any. As with the audio presentation, the visual character of the presenter animation preferably corresponds to the substantive content of the weather information 208 to be presented. Visual character logic 228 may be used to analyze the weather information content to determine the appropriate visual characteristics. For example, if the weather information 208 to be presented includes a forecast for sunny and warm weather the animated presenter may be animated to be smiling. If a storm warning is to be presented the presenter may be animated with a concerned expression.

The audio 216 and video 224 components of the animated presenter are combined and rendered 230 in a conventional manner to create the animated presenter presenting personalized weather information in accordance with the present invention. Such an animated presenter presentation may be delivered to the user via any appropriate addressable medium or device, such as the user's personal computer, portable cellular phone or other hand held device with video capability, addressable digital television system, etc.

The present invention is not limited to the particular exemplary applications and embodiments illustrated and described herein.

We claim:

1. A computer-implemented personalized weather presentation method, comprising:
(a) receiving weather personalization inputs (40) including at least a selection of a location of interest and a weather information type;
(b) generating personalized weather information (68) based on the location of interest and the weather information type; and
(c) presenting the personalized weather information (68) using a user-selected weather presentation animated presenter (232).

2. The method of claim 1, further including generating an audio stream (216) representative of the personalized weather information (68).

3. The method of claim 2, wherein the audio stream (216) is a presentation of the personalized weather information (68) configured to imitate a human weatherman presentation.

4. The method of claim 2, wherein presenting the personalized weather information using a user-selected weather presentation avatar includes configuring (232) the user-selected weather presentation animated presenter (232) such that the avatar appears to be presenting the audio stream (216).

5. The method of claim 3, wherein configuring the user-selected weather presentation animated presenter includes animating (222) the animated presenter such that the mouth and facial movements of the animated presenter (232) correspond realistically to the audio stream (216).

6. The method of claim 1, wherein presenting the personalized weather information (68) using a user-selected weather presentation animated presenter (232) includes receiving a selection of a weather presentation avatar from a group of weather presentation animated presenters (226).

7. The method of claim 1, wherein at least one of the appearance and presentation of the weather presentation animated presenter (232) is modified based on the content of the personalized weather information (214, 222).

8. A computer-implemented personalized weather presentation system, comprising:
(a) a database (62) configured to store weather personalization inputs (40) including at least a selection of a location of interest and a weather information type for a plurality of users;
(b) a personalized weather information generator (12) configured to generate personalized weather information (68) based on the location of interest and the weather information type; and
(c) a personalized weather information presentation system (210) configured to present the personalized weather information (68) using a user-selected weather presentation animated presenter (232).

9. The system of claim 8, wherein the personalized weather information presentation system is configured to generate an audio stream (216) representative of the personalized weather information (68).

10. The system of claim 9, wherein the audio stream (216) is a presentation of the personalized weather information (68) configured to imitate a human weatherman presentation.

11. The system of claim 9, wherein presenting the personalized weather information (68) using a user-selected weather presentation avatar includes configuring (230) the user-selected weather presentation animated presenter (232) such that the avatar appears to be presenting the audio stream (216).

12. The system of claim 11, wherein configuring the user-selected weather presentation animated presenter (232) includes animating (222) the animated presenter such that the mouth and facial movements of the animated presenter correspond realistically to the audio stream (216).

13. The system of claim 8, wherein presenting the personalized weather information (68) using a user-selected weather presentation animated presenter (232) includes receiving a selection of a weather presentation avatar from a group of weather presentation animated presenters (226).

14. The system of claim 8, wherein at least one of the appearance and presentation of the weather presentation animated presenter (232) is modified based on the content of the personalized weather information (214, 222).

15. A computer-implemented personalized weather presentation method, comprising:
(a) generating personalized weather information (68); and
(b) presenting the personalized weather information (68) using a user-selected weather presentation animated presenter (232), the presentation being configured based on the content of the generated personalized weather information (214, 222).

16. The method of claim 15, wherein presenting the personalized weather information (68) includes generating an audio stream (216) representative of the personalized weather information (68).

17. The method of claim 16, wherein presenting the personalized weather information (68) using a user-selected weather presentation animated presenter (232) includes configuring (230) the presenter (232) such that the presenter (232) appears to be speaking the audio stream (216).

18. The method of claim 17, wherein configuring the user-selected weather presentation animated presenter (232) includes animating (222) the animated presenter such that the mouth and facial movements of the animated presenter correspond realistically to the audio stream (216).

19. The method of claim 15, wherein presenting the personalized weather information (68) includes selecting one or more pre-defined phrases and corresponding animations based on the content of the personalized weather information (68).

20. The method of claim 15, wherein at least one of the appearance and presentation of the weather presentation animated presenter (232) is modified based on the content of the personalized weather information (68).
